(19) United States
(12) Patent Application Publication
(10) Pub. No.: US 2017/0282647 A1
(43) Pub. Date: Oct. 5, 2017

(54) INNER LINERS COMPRISING LOW ACID NUMBER ROSIN ESTERS

(71) Applicants: Hannes Hendrik Peter VAN ERP, Almere (NL); Wolfgang PILLE-WOLF, Wokuhl-Dabelow (DE); Arizona Chemical Company, LLC, Jacksonville, FL (US)

(72) Inventors: Hannes Hendrik Peter VAN ERP, Almere (NL); Wolfgang PILLE-WOLF, Wokuhl-Dabelow (DE)

(73) Assignee: Arizona Chemical Company, LLC, Jacksonville, FL (US)

(21) Appl. No.: 15/519,750

(22) PCT Filed: Dec. 17, 2015
(86) PCT No.: PCT/EP2015/080296

§ 371 Date: Apr. 17, 2017

(30) Foreign Application Priority Data
Dec. 23, 2014 (EP) 14200147.8

(51) Int. Cl. B60C 1/00; C08L 93/04; C08K 3/04; C08L 23/22

(52) U.S. Cl. CPC B60C 1/0008; C08L 23/22; C08L 93/04; C08K 3/04

(57) ABSTRACT

The instant invention relates to an inner liner formulation comprising a rosin ester with a low acid number and a butyl rubber, to a tire inner liner comprising said inner liner formulation, and to a method for providing an inner liner formulation, wherein the rosin ester has an acid number of at most 15 mgKOH/g.

The instant invention relates to an inner liner formulation comprising a rosin ester with a low acid number and a butyl rubber, to a tire inner liner comprising said inner liner formulation, and to a method for providing an inner liner formulation.

Inner liners are tire components which are disposed radially inwardly in a tire, and serve to improve air permeability resistance by reducing an amount of leakage of air from inside to outside of the pneumatic tire. Inner liners generally comprise a rubber and other components such as fillers, oils, curing additives and, optionally, processing additives. The term rubber is also referred to in the art as elastomer. In the instant description the terms rubber and elastomer will be used interchangeably.

The properties required for an inner liner are significantly different to those required for other tire components of the tire, such as the tread, which is in contact with the road or the carcass of the tire, which provides structure to the tire. In particular, for the good performance and durability of an inner liner it is important that crack resistance is guaranteed to ensure low air permeability and prevent air leakage.

U.S. patent application Nos. 2013/0230697 and 2014/0060719 describe compositions useful as inner liners comprising a thermoplastic elastomer composition containing a styrene-isobutylene-styrene block copolymer. These documents describe that the crack growth can be reduced or the cracking resistance may be improved by improving the adhesion between the inner liner and other components of the tire. This is achieved by using a ribbon-shaped strip of a thermoplastic elastomer composition having a specific shape to form the inner liner or by providing the inner liner with specific dimensions.

The use of additives has also been described to improve the cut resistance of elastomer compositions. For instance, in JP Patent No. 48-038615 cyclopentadiene resin is added to styrenebutadiene elastomeric copolymer for improving the cut resistance. Similarly, in JP Patent No. 50-138043 a diene polymer is modified with a cyclopentadiene phenol resin for improving cut resistance and flex cracking. However, additives that may be suitable to improve crack resistance may have detrimental effects on, e.g., air permeability, processing properties and/or cure properties of the formulations to which they are added.

The inventors have now found that rosin esters with a low acid number, i.e. of at most 15 mgKOH/g, can be used in inner liner formulations comprising butyl rubber, resulting in a formulation with good crack resistance properties without significantly detrimentally affecting the air permeability, processing and curing properties of the formulation. In particular, it has now been found that said low acid number rosin esters can display improved crack resistance and/or green tack when compared to other additives typically used in inner liner formulations.

GB Patent Nos. 875,351 and 876,697 describe rubbery compositions comprising butyl rubber and additives such as esters of modified rosins. However, these documents do not disclose inner liner applications or acknowledge the advantages of rosin esters with low acid numbers for inner liner formulations.

Rosin esters have been described for use as additives for tire formulations. Reference is made to for instance U.S. patent application Nos. 2013/0184397 and 2009/0186965. These documents describe elastomeric compositions incorporating a hydrocarbon polymer modifier suitable for tire components, including inner liners. Hydrocarbon polymer modifiers specifically mentioned include, among other types of compounds, gum rosins, gum rosin esters, wood rosins, wood rosin esters, tall oil rosins, tall oil rosin esters, and hydrogenated rosin esters. However, the use of rosin esters having a low acid number is not suggested, let alone that such rosin esters have advantageous effects for inner liner formulations comprising butyl rubber as found by the inventors.

Accordingly, in several aspects, the instant invention relates to an inner liner formulation comprising a rosin ester and a butyl rubber, wherein the rosin ester has an acid number of at most 15 mgKOH/g.

Rosin esters can be formed by the esterification of rosin. Rosin, also called colophony or Greek pitch (Pix græca), is a hydrocarbon secretion of plants, typically of conifers such as pines (e.g., Pinus palustris and Pinus caribaea). Rosin can include a mixture of rosin acids, with the precise composition of the rosin varying depending in part on the plant species. Rosin acids are C₂₀ fused-ring carboxylic acids with a nucleus of three fused six-carbon rings, sometimes bicyclic compounds, containing double bonds that vary in number and location. Examples of rosin acids include abietic acid, neoabietic acid, dehydroabietic acid, pimaric acid, levopimaric acid, sandaracopimaric acid, isopimaric acid, palustric acid, elliotic acid and mercusic acid. Natural rosin typically consists of a mixture of seven or eight rosin acids, in combination with minor amounts of other components.

Rosin is commercially available, and can be obtained from pine trees by distillation of oleoresin (gum rosin being the residue of distillation), by extraction of pine stumps (wood rosin) or by fractionation of tall oil (tall oil rosin). Any type of rosin can be used to prepare the rosin esters described herein, including wood rosin, gum rosin, tall oil rosin and mixtures thereof. In certain embodiments, the rosin ester is derived from tall oil rosin. Examples of commercially available rosins include tall oil rosins such as SYLVAROS™ NCY, commercially available from Arizona Chemical.

Rosins can be used as a feedstock for the formation of rosin esters as obtained from a commercial or natural source. Alternatively, rosin can be subjected to one or more purification steps (e.g., distillation under reduced pressure, extraction, and/or crystallization) prior its use as a feedstock for the formation of rosin esters. If desired, one or more purified rosin acids (e.g., abietic acid, neoabietic acid, pimaric acid, levopimaric acid, sandaracopimaric acid, isopimaric acid, palustric acid, dehydroabietic acid, dihydroabietic acid, or combinations thereof) can be used as a feedstock for the formation of a rosin ester in place of rosin.

Rosin esters can be obtained from rosin and suitable alcohols using a variety of methods known in the art. Reference is made, for example, to U.S. Pat. No. 5,504,152, which is hereby incorporated by reference in its entirety. Suitable methods for preparing the rosin esters can be selected in view of the desired chemical and physical properties of the resultant rosin esters.

Methods for esterifying rosin can include contacting the rosin with an alcohol, and allowing the rosin and the alcohol to react for a period of time and under suitable conditions to form a rosin ester. For example, rosin can be esterified by a thermal reaction of the rosin with an alcohol. In some such embodiments, methods can involve contacting molten rosin with an alcohol for a period of time suitable to form a rosin ester.

The amount of alcohol employed in the esterification process relative to the amount of rosin can be varied, depending on the nature of the alcohol and the desired chemical and physical properties of the resultant rosin ester. In general, the alcohol is provided in excess so as to produce a rosin ester having a low acid number. For example, the alcohol can be provided in an amount such that more than a molar equivalent of hydroxy groups is present in the reaction relative to the amount of carboxylic acids of rosin present.

Suitable alcohols to form the rosin esters include monoalcohols and polyhydric alcohols (e.g. diols and other polyols). In several embodiments, a rosin ester as described herein may be an ester of a polyhydric alcohol and rosin.

Examples of suitable alcohols include glycerol, pentaerythritol, dipentaerythritol, sorbitol, trimethylolpropane, trimethylolethane, mannitol, and C₈-C₁₁ branched or unbranched alkyl alcohols. In certain embodiments, the alcohol is a polyhydric alcohol selected from the group consisting of pentaerythritol, glycerol, trimethylolpropane, trimethylolethane, mannitol, and combinations thereof. Preferably the alcohol may be a polyhydric alcohol selected from pentaerythritol, and glycerol. In several embodiments, more than one alcohol is used to form the rosin esters. In certain embodiments, pentaerythritol and glycerol may be used to form the rosin esters.

As is known in the art, catalysts, bleaching agents, stabilizers, and/or antioxidants can be added to the esterification reaction. Suitable catalysts, bleaching agents, stabilizers, and antioxidants are known in the art, and described, for example, in U.S. Pat. Nos. 2,729,660, 3,310,575, 3,423,389, 3,780,013, 4,172,070, 4,548,746, 4,690,783, 4,693,847, 4,725,384, 4,744,925, 4,788,009, 5,021,548, and 5,049,652.

In order to drive the esterification reaction to completion, water can be removed from the reactor using standard methods, such as distillation and/or application of a vacuum.

Following the esterification reaction, unreacted rosin as well as other volatile components can be removed from the resultant rosin ester product, for example, by steam sparging, sparging by an inert gas such as nitrogen gas, wiped film evaporation, short path evaporation, and vacuum distillation. This results in stripping any excess rosin acid from the rosin ester products, reducing the acid number of the rosin ester. Following esterification, the resultant rosin ester can comprise low amounts of residual, unreacted rosin acid and/or alcohol.

To obtain a rosin ester having specific chemical and physical properties, preparation of the rosin esters can optionally further include one or more additional processing steps. As described above, the rosin acids (e.g., abietadienoic acids) can include conjugated double bonds within their ring systems. These conjugated double bonds can be a source of oxidative instability. Accordingly, in some embodiments, the rosin to be esterified and/or the rosin ester formed by esterification can be processed to decrease the number of conjugated double bonds. Methods of reducing the number of conjugated double bonds of rosin or a rosin ester are known in the art, and include hydrogenation, dehydrogenation, disproportionation, dimerization, and fortification. In certain embodiments, rosin is processed using one or more of these methods prior to esterification to improve the chemical and physical properties of the resultant rosin esters. Where chemically permissible, such methods can also be performed in combination with esterification and/or following esterification. However, it may be preferred that the rosin ester does not result from a process wherein the rosin or the rosin ester is subjected to any of hydrogenation, dehydrogenation, disproportionation, dimerization, and fortification.

A rosin ester incorporated in formulations provided herein has a low acid number of at most 15 mgKOH/g, expressed as milligrams of potassium hydroxide (mgKOH) necessary to neutralize a gram of rosin ester sample and as determined according to the method described in ASTM D465-05 (2010). In particular, the acid number may be of at most 10 mgKOH/g, in particular of at most 7.5 mgKOH/g, more in particular of at most 5 mgKOH/g, and even more in particular at most 4.5 mgKOH/g. In several particular embodiments the acid number may be of at most 3 mgKOH/g or even at most 1 mgKOH/g.

Rosin esters with a low acid number as described herein can be used to provide inner liner formulations with a good cracking resistance whilst not significantly detrimentally affecting the curing and processing properties of the inner liner formulation. It has been found that said low acid number rosin esters provide formulations with a cracking resistance which is even improved with respect to other components typically used in inner liner formulations, such as aromatic or aliphatic hydrocarbon resins.

A rosin ester as described herein may have a softening point from 70 to 150° C., in particular from 75 to 125° C. and more in particular from 80 to 105° C. The softening point can be measured by the Ring and Ball method (ASTM E28-99), whereby a sample of the rosin-containing material is poured molten into a metal ring, and is subsequently cooled. The ring is cleaned in such a way that the rosin-containing material fills the ring, a steel ball is placed resting on top of the resin. The ring and ball are placed in a bracket which is lowered into a beaker containing a solvent (e.g. water, glycerol or silicone oil depending on the expected softening point), and the solvent is heated at 5° C. per minute while being stirred. When the ball drops completely through the ring, the temperature of the solvent is recorded as the Ring & Ball softening point.

The rosin ester can have a weight average molecular weight, as determined using gel permeation chromatography (GPC) as described in ASTM D5296-05, of at least 600 g/mol, more in particular of at least 700 g/mol. The rosin ester can have a weight average molecular weight of at most 6500 g/mol, in particular of at most 4500 g/mol, and more in particular of at most 2200 g/mol.

A low acid number rosin ester in an inner liner formulation as described herein may generally be present in an amount from 1 to 20 phr, in particular from 2 to 15 phr, more in particular from 2.5 to 10 phr, and even more in particular from 5 to 7.5 phr. Phr is a term commonly used in the art of rubber formulations and refers to parts of component (e.g. rosin ester) per hundred parts of rubber. Lower amounts of rosin ester may not show a significant effect in the formulation and higher amounts of rosin esters may not significantly improve the properties of the formulation or may even detrimentally effect some of the properties of the formulation.

In several embodiments the amount of rosin ester may be varied depending on the acid number of the rosin ester. For instance, when the rosin ester has an acid number of at most 5 mgKOH/g then the amount may be from 10 to 20 phr and when the rosin ester has an acid number from 5 to 15 mgKOH/g the amount may be from 1 to 10 phr. It has been found that rosin esters with lower acid numbers (e.g. of at most 5 mgKOH/g) may be used in higher quantities without adversely affecting curing properties. Even though rosin esters with higher acid numbers from 5 to 15 mgKOH/g can also be satisfactorily used in any amounts, the use of lower amounts (e.g. from 1 to 10 phr) has been found to favor the curing properties of the resulting formulations.

As indicated above, inner liner formulations as described herein contain butyl rubber.

Butyl rubber is an elastomeric copolymer of isobutylene with isoprene, also known in the art as isobutyleneisoprene rubber (IIR). The major component of butyl rubber is isobutylene and may generally comprise up to 2.5 wt. % of isoprene. Butyl rubber may be branched (e.g. “star-branched” butyl rubber). Examples of useful butyl rubbers are well known and are described in RUBBER TECHNOLOGY, p. 209-581 (Morton, ed., Chapman & Hall 1995), THE VANDERBILT RUBBER HANDBOOK, p. 105-122 (Ohm ed., R.T. Vanderbilt Col., Inc. 1990), and Kresge and Wang in 8 KIRK-OTHMER ENCYCLOPEDIA OF CHEMICAL TECHNOLOGY, p. 9340955 (John Wiley & Sons, Inc. 4th ed. 1993), each of which are incorporated herein by reference.

In several embodiments the butyl rubber is halogenated, i.e. has halogen groups, which is also referred to in the art as halobutyl rubber. Halobutyl rubber may preferably have Cl and/or Br groups, and more preferably is bromobutyl rubber, i.e. has Br groups.

Butyl rubber and halobutyl rubber are well known in the art and are commercially available. Reference is made to, for instance, bromobutyl rubbers such as LANXESS X_Butyl™ BB 2030, LANXESS X_Butyl™ BB 2040, LANXESS X_Butyl™ BB 2230, and LANXESS X_Butyl™ BB X2; regular butyl rubber such as LANXESS X_Butyl™ RB 402, and LANXESS X_Butyl™ RB 301; and chlorobutyl rubber such as LANXESS X_Butyl™ CB 1240, all available from Lanxess. Other suitable butyl rubbers may include, for instance, Exxon™ bromobutyl 2222, Exxon™ bromobutyl 2235, Exxon™ bromobutyl 2255, Exxon™ chlorobutyl 1066 from ExxonMobil, or Bromobutyl rubber BBK-232, Bromobutyl rubber BBK-239, Bromobutyl rubber BBK-246, Chlorobutyl rubber CBK-139, Chlorobutyl rubber CBK-150, Butyl rubber BK-16/5N, from Nizhnekamskneftekhim (NKNK).

An inner liner formulation as described herein may also comprise, in addition to butyl rubber, other rubbers. For instance, rubbers typically used in the art for inner liner formulations may be used. The total rubber content in the inner liner formulation, including butyl rubber and any additional rubber, is expressed as 100 phr.

Examples of suitable additional rubbers may include, for instance, polyisobutylene rubber, random copolymers of isobutylene and para-methylstyrene (e.g. poly(isobutylene-co-p-methylstyrene)), polybutadiene rubber (BR), polyisobutylene, cis-polybutadiene (cis-BR), high cis-polybutadiene (i.e. polybutadiene rubber wherein the amount of the cis component is at least 95%), polypropylene rubber, polyisoprene rubber (IR), isoprene-butadiene rubber (IBR), styrene-isoprene-butadiene rubber (SIBR), styrene-butadiene rubber (SBR), solution-styrene-butadiene rubber (sSBR), emulsion-styrene-butadiene rubber, high styrene rubber (HSR), nitrile rubber, ethylene propylene rubber (EP), ethylenepropylene-diene rubber (EPDM), polyisoprene (e.g. 1,4-polyisoprene), natural rubber, and any halogenated versions of these rubbers, in particular halogenated random copolymers of isobutylene and para-methylstyrene, and mixtures thereof. Useful rubbers are commercially available or can be made by any suitable means known in the art. Natural rubber may be preferred as additional rubber. In several embodiments natural rubber may be added to butyl or halobutyl rubber, e.g., in order to improve the mechanical properties of the rubber. However the addition of natural rubber may detrimentally affect air permeability.

In several embodiments, inner liner formulations as described herein may comprise additional rubbers but may not comprise styrene-isobutylene-styrene rubber, styrene-isoprene-styrene rubber, and/or polypropylene rubber, in particular may not comprise styrene-isobutylene-styrene rubber and styrene-isoprene-styrene rubber. In several embodiments inner liner formulations as described herein may even not comprise polyisoprene rubber (e.g. natural rubber).

It may be generally preferred that butyl rubber is the major rubber component of an inner liner formulation as described herein. For instance, butyl rubber may generally constitute at least 25 wt. % of all the rubber present in an inner liner formulation as described herein, in particular at least 50 wt. %, more in particular at least 75 wt. %, even more in particular at least 90 wt. %, 95 wt. %, 98 wt. % or even at least 99 wt. %. In several embodiments butyl rubber is the sole rubber present in an inner liner formulation as described herein, i.e. butyl rubber constitutes 100 wt. % of all the rubber present in the inner liner formulation, in other words, the inner liner formulation does not comprise rubbers other than butyl rubber. In particular, the rubber may be 100% halobutyl rubber and even more in particular the rubber may be 100% bromobutyl rubber.

Inner liner formulations as described herein may comprise components other than low acid rosin ester and rubber, such as additives customarily used in rubber formulations.

Such additives include, for instance, fillers, processing aids, curing agents (also referred to in the art as vulcanizing agents including, cross-linking agents, accelerators, activators, and retardants), antioxidants, and/or antiozonants.

A filler may be selected from, for example, carbon black, calcium carbonate, clay, mica, silica, silicates, talc, titanium dioxide, aluminum oxide, zinc oxide, starch, wood flour, or mixtures thereof. Carbon black may be preferred as a filler. In several embodiments the inner liner formulations do not comprise silica and nanoclays, as these fillers may increase the costs and may be of difficult access.

In several particular embodiments the only filler present in the inner liner formulations is carbon black. A filler may generally be present in inner liner formulations as described herein in amounts of 10 to 105 phr, in particular from 25 to 85 phr, from 50 to 75 phr.

The term processing aid as used herein refers to any component which assists the processing of the inner liner formulations by, e.g., reduction of the compound viscosity to enable easier processing, improvement of dispersion and incorporation of fillers, improvement of mixing of different rubber types, improvement of green tack, and improvement of flow of the compound in the curing mold. Processing aids are known in the art and may be selected from, e.g., processing oils (e.g. naphthenic oil, paraffinic oil, and aromatic oil), hydrocarbon polymer modifiers (e.g. aliphatic hydrocarbon resins, aromatic hydrocarbon resins, aromatic modified aliphatic hydrocarbon resins, hydrogenated polycyclopentadiene resins, polycyclopentadiene resins, polybutene, polyterpenesphenolic resins (e.g. phenol-formaldehyde or phenolacetaldehyde resins), coumarone resins, coumarone-indene resins, bitumen, aromatic modified hydrogenated polycyclopentadiene resins, hydrogenated aliphatic resin, hydrogenated aliphatic aromatic resins, hydrogenated terpenes and modified terpenes, gum rosins, wood rosins, tall oil rosins, and rosin esters other than a rosin ester with a low acid number as described herein), fatty acid based modifier (e.g. Fatty acid, fatty acid esters, metal soaps of fatty acids, fatty acid amides, fatty alcohols), organosilicones, PE and PP wax.

However, the presence of the low acid rosin ester in the inner liner formulations as described herein general preclude the need for such processing aids, especially in view of the overall good properties of the resulting inner liner formulations. Accordingly, in several embodiments, inner liner formulations as described herein may not contain processing aids other than rosin esters having a low acid number as described herein. For instance, inner liner formulations as described herein may not contain processing oils such as paraffinic oil.

Inner liner formulations as described herein and the articles made from those formulations, are generally manufactured with the aid of at least one curing agent. Accordingly, an inner liner formulation as described herein may comprise a curing agent. The term curing agent as used herein generally refers to such additives that impart curing properties to the formulation and that facilitate or modulate its vulcanization, including, e.g., cross-linking agents, activators, accelerators, and retardants.

In particular, activators are chemicals that increase the rate of vulcanization by reacting first with the accelerators to form rubber-soluble complexes which then react with, e.g., the sulfur to form sulfurating agents. Accelerators help control the onset of and rate of vulcanization, and the number and type of crosslinks that are formed. Retarders may be used to delay the initial onset of cure in order to allow sufficient time to process the unvulcanized rubber. Cross-linking agents are compounds which are capable of crosslinking, either intermolecularly or intramolecularly, one or more strands of a rubber polymer. To that effect cross-linking agents have reactive groups such as an unsaturation.

Curing agents, may include, for example, sulfur, sulfur compounds, metals, metal oxides (e.g. zinc oxide, calcium oxide and lead oxide), peroxides (e.g. alkylperoxide), organometallic compounds (e.g., metal fatty acid complexes such as zinc stearate and calcium stearate), radical initiators, fatty acids (e.g. stearic acid), nitrogen and/or sulfur containing organic compounds (e.g. amines, diamines, guanidines, thioureas, thiazoles, thiurams, sulfenamides, sulfenimides, thiocarbamates, and xanthates), polyfunctional organic compounds (e.g. having at least two groups selected from a thiosulfate group, mercapto group, aldehyde group, carboxylic acid group, peroxide group, and alkenyl group), and other agents common in the art.

Butyl rubber may be cured using sulfur in combination with an activator and an accelerator (e.g. a combination of sulfur, zinc oxide, stearic acid and MBTS). In other embodiments butyl rubber may be cured by addition of a reactive curing resin (e.g. alkyl phenol-formaldehyde resins, specifically octylphenol-formaldehyde resins) in combination with an halogen donating material (e.g. Tin(II)Chloride or polychloroprene elastomer). The addition of a halogen donating material is not needed when bromomethylated alkylphenol formaldehyde resins are used as reactive curing resin.

Halobutyl rubbers, e.g. bromobutyl rubbers, may be cured by using sulfur and/or zinc oxide (with or without stearic acid), preferably a mixture of sulfur, zinc oxide, stearic acid and an accelerator (such as MBTS).

In several embodiments, inner liner formulations as described herein may comprise a curing agent in an amount from 0.2 to 15 phr, in particular from 0.5 to 10 phr, and more in particular from 0.75 phr to 7.5 phr, and yet more in particular from 1 phr to 6 phr. The amount of curing agent includes any component used as curing agent including cross-linking agents, activators, accelerators, and retardants.

Antioxidants and/or antiozonants may also be present in inner liner formulations as described herein.

In several embodiments an inner liner formulation as described herein may comprise butyl rubber (e.g. halobutyl rubber), a low acid number rosin ester, a filler (e.g. carbon black), and a curing agent (e.g. sulfur in combination with stearic acid, zinc oxide and, optionally, vulcanization accelerators such as di(benzothiazol-2-yl) disulfide (MBTS).

In particular, an inner liner formulation as described herein may comprise 100 phr of a butyl rubber (e.g. halobutyl rubber), from 2 to 15 phr of a low acid number rosin ester, 0 to 20 phr of processing oil (e.g. paraffin oil), from 25 to 80 phr of a filler (e.g. carbon black), from 1 to 6 phr of a curing agent (e.g. sulfur in combination with stearic acid, zinc oxide and di(benzothiazol-2-yl) disulfide (MBTS)).

In several aspects, the instant invention further relates to a method for providing an inner liner formulation comprising mixing a low acid number rosin ester with a butyl rubber.

Inner liner formulations as described herein may be prepared by methods known in the art. In particular, a method for preparing an inner liner composition as described herein may comprise mixing a butyl rubber, a low acid number rosin ester, and, optionally, any additional components using apparatuses and methods known in the art. The different components may be mixed in any order. What has been described above for the inner liner formulation, regarding the individual amounts of the different components and particular examples of each of the components, also applies to the method of preparation as described herein.

Mixing may be performed in a single step or in multiple stages. For example, the components may be mixed in at least two steps, namely at least one non-productive step followed by a productive mixing step. Generally, the rubber and the low acid number rosin ester and, optionally, any fillers may be mixed together in at least one non-productive step, to provide a masterbatch, or non-productive composition, and any curing agents may be added to the masterbatch in said at least one subsequent productive mixing step. In the productive mixing step(s) the mixing may typically occur at a temperature lower than the mixing temperature(s) of the preceding non-productive mixing step(s). The terms “non-productive” and “productive” are well known to those having skill in the art. In particular, non-productive rubber compositions lack any curing agents, and therefore no cross-linking will occur.

Suitable mixing devices may include, e.g., a two-roll mill, a BRABENDER™ internal mixer, a BANBURY™ internal mixer (e.g. with tangential rotors), Krupp internal mixer (e.g. with intermeshing rotors), and a mixer/extruder.

Mixing may be performed at temperatures up to the melting point of the rubbers used in the composition. Suitable temperatures may be from 40° C. to 200° C., in particular from 100° C. to 160° C.

In several embodiments, from 70% to 100% of the butyl rubber and any other rubber may be first mixed for 20 to 90 seconds, or until the temperature reaches from 40° C. to 75° C. Then, from 60 to 85% of the filler, and the remaining amount of rubber, if any, may be added to the mixer, and mixing continues until the temperature reaches from 90° C. to 150° C. Next, the remaining filler may be added, as well as the low acid number rosin ester and any processing aids, and mixing continues until the temperature reaches from 140° C. to 190° C. This mixture, also referred to masterbatch mixture, can be finished by sheeting on an open mill and allowed to cool, for example, to from 60° C. to 100° C. Curing agents may then be added to said masterbatch for mixing in a productive mixing step to provide a productive mixture. This productive mixture will lead to a cross-linked inner liner formulation when subjected to curing conditions. Herein, the cross-linked inner liner formulation will be referred to as cured inner liner formulation, which in the art is also known as vulcanized. Accordingly, the method of preparation as described herein may further comprise curing said productive mixtures to provide a cured inner-liner formulation. Curing may be performed by any suitable means, such as subjecting the inner liner formulations to heat or radiation according to any conventional curing process. The amount of heat or radiation needed is that which is required to affect a cure in the composition. Typically, curing may be conducted at a temperature ranging from 100° C. to 250° C., in particular from 150° C. to 200° C., for 1 to 150 minutes.

It has been found that inner liner formulations as described herein have advantages both as uncured inner liner formulations (non-productive and productive) and as cured inner liner formulations.

Accordingly, in several embodiments the inner liner formulations as described herein may be uncured or cured. In several particular embodiments, uncured inner liner formulations may be non-productive or productive.

Advantageously, inner liner formulations as described herein display good overall properties and may even improve the manufacture and the final properties of products comprising the same.

For instance, inner liner formulations as described herein have been found to display good cracking resistance properties, whilst maintaining good air permeability, processing and curing properties.

In particular, low acid number rosin esters as described herein may be used to provide inner liner formulations with improved cracking resistance, when compared to similar inner liner formulations without low acid number rosin esters as described herein or comprising other additives typically used in the art. The term ‘similar composition’ means a comparison composition which is the same as the composition of the invention in all its components and as regards to the selection of materials and amounts thereof with the exception that the similar composition does not contain low acid number rosin ester. Similar compositions may comprise another additive replacing the amount of said low acid number rosin ester.

The crack resistance of the inner liner formulations can be measured by methods known in the art. In particular De Mattia crack growth test may be used such as the method defined by ISO 132. In short, a cut is made in a cured sample of the inner liner formulation and the sample is pierced. The samples is flexed until the crack has increased by 2 mm in width (L+2) and the number of flexing cycles is noted. The test is continued until the width has increased by 6 mm (L+6), followed by flexing until the width has increased by 10 mm (L+10) or until a total of 2750 kcycles is reached. An inner liner formulation as described herein may generally have a total De Mattia crack growth cycles (L to L+10) of at least 1500 kcylces, in particular at least 2000 kcylces, kcycles meaning 1000 cycles.

The processing properties of the inner liner formulations can be evaluated by assessing, the Mooney viscosity and the Mooney Scorch, and the curing characteristics of the formulation.

The Mooney viscosity provides an indication of viscosity of the compound, indicating the processability of the compound. If the viscosity is too high it will be difficult to mix but if it is too low the dispersion and mixing will not be optimal. The Mooney Scorch provides a measure of the curing characteristic, most predominantly the scorch time; indicating the time available for processing without significant premature curing of the material. They can be determined by methods known in the art such as the method defined by ISO 289. In short, the Mooney viscosity is determined by measuring the force needed to rotate a spindle covered in rubber, inside heated dies. The measurement of the Mooney Scorch is mostly performed at a higher temperature than the Mooney viscosity, leading to curing of the compound. The increase in viscosity over time is a measure of the progression of the curing process and allows for determination of the scorch time. Inner liner formulations as described herein may generally have a t₅ Mooney scorch of at least 10 min, in particular of at least 15 min; a t₃₅ Mooney scorch of at least 20 min, in particular of at least 23 min and/or a Mooney viscosity of 50 to 75 Mu (Mooney units).

The green tack provides an indication of adhesion of the uncured rubber compound to other components of the tire. The green tack can be determined by methods known in the art such as the Tel-Tak method (J. R. Beatty, Tel-Tak: A Mechanical Method for Estimating Both Tackiness and Stickiness of Rubber Compounds, Rubber Chemistry and Technology, 1969, Vol. 42, No. 4, p. 1040-1053). In short, two samples of the same formulation are pressed together for a brief amount of time, after which the force required to remove the samples from one another is measured. A higher green tack is considered beneficial for the building of the tire, before curing in the mold. Inner liner formulations as described herein may generally have a green tack adhesion of at least 15 ounces, in particular at least 20 ounces.

The air permeability of the inner liner formulations may be measured by methods known in the art such as the method defined by ASTM D1434. In short the sample is mounted in a gas transmission cell so as to form a sealed semibarrier between two chambers. One chamber contains air at a specific high pressure, and the other chamber, at a lower pressure, receives the permeating gas. The lower pressure chamber is maintained near atmospheric pressure and the transmission of the gas through the test specimen is indicated by a change in volume. Inner liner formulations as described herein may generally have an air permeability from 7.0*10⁻⁹ cm²/sec*atm to 2.5*10⁻⁸ cm²/sec*atm.

The curing properties of the inner liner formulations can be determined by methods known in the art such as the Moving Die Rheometer (MDR) method described by ISO 6502. In short, measurements are taken on a rubber sample which is pressed in between two dies, of which one is oscillating. Inner liner formulations as described herein may generally have a maximum torque of 0.4 to 0.7 Nm, in particular from 0.5 to 0.6 Nm; a t₉₀ of at least 5 min, in particular at least 6 min; and a Delta S of 0.3 to 0.6 Nm, in particular 0.35 to 0.5 Nm.

The t₉₀ provides an indication of the time required to fully cure the rubber compound. The maximum torque provides an indication of the stiffness of the cured rubber compound. The lower the maximum torque the softer the cured compound. The Delta S provides an indication of the increases in stiffness of the compound due to curing.

The tensile properties of the inner liner formulations can be evaluated by assessing the elongation at break, the tensile strength and the modulus. The tensile properties may be determined by methods known in the art such as the method defined by ISO 37, type 2. In short a rubber sample is stretched with a tensile tester until it breaks. The force required to stretch the sample is measured continuously.

The elongation at break provides an indication of stiffness of the sample. Inner liner formulations as described herein may generally have an elongation at break from 600% to 850%.

The modulus provides an indication of the mechanical strength of the sample. Inner liner formulations as described herein may generally have a modulus at 300% elongation from 3.0 to 6.0 MPa, in particular from 3.5 to 5.5 MPa.

The tensile strength provides an indication of mechanical strength of the sample. Inner liner formulations as described herein may generally have a tensile strength at maximal elongation from 10 to 12 MPa, in particular from 10.1 to 11.9 MPa, more in particular from 10.25 to 11.75 MPa.

In several embodiments, inner liner formulations as described herein may generally have a total De Mattia crack growth cycles (L to L+10) of at least 1500 kcycles, in particular at least 2000 kcycles and a green tack adhesion of at least 15 ounces, in particular at least 20 ounces. Additionally inner liner formulations as described herein may generally have a t₉₀ from 5 to 10 min, in particular from 6 to 9 min.

Several aspects of the instant invention relate to the use of a low acid number rosin ester in an inner liner composition comprising butyl rubber, for providing an inner liner with good overall properties, in particular a combination of good physical properties and good processing properties and more in particular good crack resistance whilst maintaining good air permeability, good curing properties and/or green tack.

The instant invention further relates to a tire inner liner comprising the inner liner formulation as described herein.

The invention is further illustrated with the following examples, without being limited thereto or thereby.

### EXAMPLES

The performance of inner liner formulations was assessed comprising butyl rubber and a resin. The resins used were a low acid rosin esters according to the instant invention (resins A and B) and, as comparative examples, other resins including a rosin acid with a high acid number (resin C), and two homogenizer resins (resin D and E) commonly used in rubber formulations.

Resin A was a glycerol tall oil rosin ester having an acid number of 4.3 mgKOH/g, a MW of 893 g/mol and a softening point of 81.7° C. Resin A was obtained by esterification of tall oil rosin with a slight excess of glycerol in the presence of a suitable disproportionation catalyst (e.g. Lowinox™ TBM-6) and a suitable esterification catalyst (e.g. Zinc acetate or Magnesium acetate), as is known to a person skilled in the art. After completion of the esterification the ring & ball softening point was increased and acid number reduced by steam sparging until the desired values were obtained, as is known to person skilled in the art. Further reference on the art of rosin ester synthesis can be found in U.S. Pat. No. 5,969,092 and patent application WO2013/090283.

Resin B was a pentaerythritol rosin ester having an acid number of 14.8 mgKOH/g, a MW of 1043 g/mol and a softening point of 95.2° C. Resin B was obtained by esterification of tall oil rosin with a slight excess of pentaerythritol in the presence of a suitable disproportionation catalyst (e.g. Lowinox™ TBM-6) and a suitable esterification catalyst (e.g. Zinc acetate or Magnesium acetate), as is known to a person skilled in the art. After completion of the esterification the ring & ball softening point was increased and acid number reduced by steam sparging until the desired values were obtained, as is known to person skilled in the art. Further reference on the art of rosin ester synthesis can be found in U.S. Pat. No. 5,969,092 and patent application WO2013/090283.

Resin C was a tall oil rosin having an acid number of 161.4 mgKOH/g, a MW of 404 g/mol and a softening point of 70.6° C.

Resin D was dark aromatic hydrocarbon resin. Resin D was provided by Struktol under the name Struktol™ 40 MS flakes.

Resin E was a light aliphatic hydrocarbon resin. Resin E was provided by Struktol under the name Struktol™ 60 NS flakes.

The selected resins were mixed into an innerliner formulation based on bromobutyl rubber. The resins were tested at different dosage levels of 2.5, 5 and 10 phr (exchanged against process oil). The control formulation with 10 phr of process oil was mixed in duplicate, leading to a total of 17 compounds. The bromobutyl rubber was Bromobutyl 2030, provided by Lanxess. The filler was Carbon black N-660, provided by Statex. As processing aid paraffin oil was used supplied by SUNOCO™ as Sunpar 2280. As curing agents sulfur was used in combination with zinc oxide, stearic acid and di(benzothiazol-2-yl) disulfide (MBTS) supplied by Lanxess as Vulkacit® DM/MG. The mixing was performed in a 1.6 L Banbury type internal mixer. The curing agents were mixed in on a two-roll mill.

The tested formulations used are displayed in Table 1. evaluated by the test methods displayed in Table 2.

The Mooney viscosity and Mooney scorch, the cure characteristics and the green tack were performed on the formulations of table 1 without further processing.

The inner liner formulations obtained were made into 2 mm thick sheets for assessing the tensile properties, into 0.51 mm thick samples for assessing the air permeability and into 6 mm De Mattia samples for assessing the crack resistance. All 2 mm thick tensile sheets and 0.51 mm thick air permeability samples were cured for 12 minutes at 160° C. The 6 mm thick De Mattia samples were cured for 18 minutes at 160° C.

TABLE 1
Formulation of the inner liner test compounds.

| Inner liner | | | | |
|---|---|---|---|---|
| formulation | 1 | 2 | 3 | 4 |
| | Amount (PHR) | | | |
| Butyl rubber | 100 | 100 | 100 | 100 |
| Carbon black | 60 | 60 | 60 | 60 |
| Paraffin Oil | 10 | 7.5 | 5 | 0 |
| Resin | 0 | 2.5 | 5 | 10 |

Curing agents

| | | | | |
|---|---|---|---|---|
| MBTS | 1.3 | 1.3 | 1.3 | 1.3 |
| Stearic acid | 1 | 1 | 1 | 1 |
| ZnO | 3 | 3 | 3 | 3 |
| Sulfur | 0.5 | 0.5 | 0.5 | 0.5 |
| Total PHR | 175.8 | 175.8 | 175.8 | 175.8 |

TABLE 2
Test methods used for characterization of the inner
liner compounds.

| Property | Test method |
|---|---|
| Mooney viscosity and Mooney scorch | ISO 289 |
| Cure characteristics (MDR) at 160° C. | ISO 6502 |
| Green tack | Tel-Tak* |
| Tensile properties (tensile strength, | ISO 37, type 2 |
| elongation at break, moduli) | |
| De Mattia crack growth | ISO 132 |
| Permeability to air at 60° C. | ASTM D1434 |

*R. Beatty, Tel-Tak: A Mechanical Method for Estimating Both Tackiness and Stickiness of Rubber Compounds, Rubber Chemistry and Technology, 1969, Vol. 42, No. 4, p. 1040-1053

### De Mattia Crack Growth

For the De Mattia crack growth test a 2 mm wide cut is made in the sample and the sample is pierced. The samples is flexed until the crack has increased by 2 mm in width (L+2) and the number of cycles is noted. The test is continued until the width has increased by 6 mm (L+6), followed by flexing until the width has increased by 10 mm (L+10). The test is stopped when 2750 kcycles or L+10 is reached.

The best crack results were obtained with formulations comprising low acid number rosin esters (Resin A & B) and rosin acid (Resin C). The results are displayed on table 3.

In particular, formulations with Resin C (and 10 phr of Resin B have superior crack resistance. For compounds with 5 & 10 phr Resin C the crack does not widen beyond L+2, for 2.5 phr Resin C the 2750 kcycles are reached just beyond L+2. Also the sample with 10 phr Resin B reaches 2750 kcycles before L+6 is reached. Formulations comprising 10 phr or even 5 phr of Resin A, did not reach the 2750 kcycles, but displayed a marked improvement with respect to compositions comprising no resin (with 10 phr paraffin oil) and to compositions comprising resins D and E.

### Air Permeability

For each inner liner formulation 2 test sheets were made and tested for air permeability at 60° C.

The results from the air permeability testing are displayed on Table 4. Due to the semi-quantative nature of ASTM D1434, the air permeability test method has limited accuracy.

Based on the results displayed on Table 4 a trend can be identified towards lower air permeability with increasing dosage of homogenizer resin. However, when taking into account the error of the measurement, there appears, limited differentiation between the samples. Indicating that the presence of the resin does not significantly increase air permeability.

TABLE 3
De Mattia crack growth

| | De Mattia crack cycles (kcycles) | | | |
|---|---|---|---|---|
| | | L + 2/ | L + 6/ | Total |
| Sample | L/L + 2 | L + 6 | L + 10 | L to L + 10. |
| 10 phr paraffin oil* | 40 | 113 | 100 | 253 |
| 2.5 phr Resin A | 83 | 46 | 270 | 399 |
| 5 phr Resin A | 150 | 517 | 2 | 699 |
| 10 phr Resin A | 333 | 833 | 750 | 1917 |
| 2.5 phr Resin B | 200 | 467 | 417 | 1083 |
| 5 phr Resin B | 500 | 583 | 667 | 1750 |
| 10 phr Resin B | 2083 | 667** | — | 2750 |
| 2.5 phr Resin C | 2500 | 250** | — | 2750 |
| 5 phr Resin C | 2750** | — | — | 2750 |
| 10 phr Resin C | 2750** | — | — | 2750 |
| 2.5 phr Resin D | 100 | 300 | 433 | 833 |
| 5 phr Resin D | 216 | 533 | 501 | 1250 |
| 10 phr Resin D | 200 | 500 | 50 | 750 |
| 2.5 phr Resin E | 50 | 100 | 100 | 250 |
| 5 phr Resin E | 50 | 83 | 183 | 317 |
| 10 phr Resin E | 67 | 127 | 107 | 300 |

*average of two samples
**2750 kcycles reached, test stopped.

TABLE 4
Air permeability

| | Permeability |
|---|---|
| Sample | (cm²/sec*atm) |
| 10 phr paraffin oil* | 2.57 × 10⁻⁸ |
| 2.5 phr Resin A | 2.17 × 10⁻⁸ |
| 5 phr Resin A | 2.37 × 10⁻⁸ |
| 10 phr Resin A | 1.34 × 10⁻⁸ |
| 2.5 phr Resin B | 2.02 × 10⁻⁸ |
| 5 phr Resin B | 1.99 × 10⁻⁸ |
| 10 phr Resin B | 1.08 × 10⁻⁸ |
| 2.5 phr Resin C | 1.99 × 10⁻⁸ |
| 5 phr Resin C | 1.82 × 10⁻⁸ |
| 10 phr Resin C | 8.87 × 10⁻⁹ |
| 2.5 phr Resin D | 1.99 × 10⁻⁸ |
| 5 phr Resin D | 2.17 × 10⁻⁸ |
| 10 phr Resin D | 1.31 × 10⁻⁸ |
| 2.5 phr Resin E | 1.85 × 10⁻⁸ |
| 5 phr Resin E | 2.52 × 10⁻⁸ |
| 10 phr Resin E | 7.76 × 10⁻⁹ |

*average of two samples

### Green Tack

The results of the green tack measurements are presented on Table 5.

As can be seen from Table 5, compounds with low acid number rosin esters (Resins A & B) show improved green tack when compared to formulations without resin or formulation with Resins D and E. The improvement has been found to be higher for the rosin ester with the lowest acid number Resin A).

TABLE 5
Green Tack

| | Adhesion |
|---|---|
| Sample | (ounzes) |
| 10 phr paraffin oil* | 16 |
| 2.5 phr Resin A | 22 |
| 5 phr Resin A | 18 |
| 10 phr Resin A | 23 |
| 2.5 phr Resin B | 17 |
| 5 phr Resin B | 18 |
| 10 phr Resin B | 18 |
| 2.5 phr Resin C | 23 |
| 5 phr Resin C | 18 |
| 10 phr Resin C | 14 |
| 2.5 phr Resin D | 13 |
| 5 phr Resin D | 17 |
| 10 phr Resin D | 13 |
| 2.5 phr Resin E | 18 |
| 5 phr Resin E | 12 |
| 10 phr Resin E | 10 |

*average of two samples

### Mooney Viscosity and Mooney Scorch

The use of an increased amount of resin leaded to a slight increase in Mooney viscosity and a slight decrease in Mooney Scorch as can be seen in Table 6, for all samples tested except for Resin D. As can also be seen the use of low acid number rosin esters (resin A & B) does not detrimentally affect the Mooney Scorch properties with respect to the blank comprising paraffin oil, whereas rosin acid (resin C) significantly reduces the Mooney scorch. The strong reduction in Mooney scorch for resin C, indicates a limited scorch time; which might lead to premature curing of the compound during processing.

TABLE 6
Mooney properties

| | Mooney | | |
|---|---|---|---|
| | viscosity | Mooney | Mooney |
| Sample | M_{L} 1 + 4 | Scorch t₅ | Scorch t₃₅ |
| 10 phr paraffin oil* | 55.0 | 22.6 | 29.6 |
| 2.5 phr Resin A | 59.3 | 18.7 | 28.3 |
| 5 phr Resin A | 57.0 | 19.3 | 27.2 |
| 10 phr Resin A | 62.7 | 16.7 | 24.9 |
| 2.5 phr Resin B | 61.9 | 17.6 | 26.2 |
| 5 phr Resin B | 58.8 | 16.6 | 26.1 |
| 10 phr Resin B | 62.5 | 15.8 | 23.1 |
| 2.5 phr Resin C | 54.0 | 9.5 | 15.6 |
| 5 phr Resin C | 55.8 | 8.2 | 13.1 |
| 10 phr Resin C | 61.4 | 6.8 | 11.7 |
| 2.5 phr Resin D | 61.6 | 22.2 | 33.7 |
| 5 phr Resin D | 63.1 | 23.5 | 35.5 |
| 10 phr Resin D | 71.7 | 20.0 | 32.7 |
| 2.5 phr Resin E | 57.5 | 20.3 | 30.1 |
| 5 phr Resin E | 59.9 | 23.2 | 30.3 |
| 10 phr Resin E | 62.6 | 18.7 | 29.9 |

*average of two samples

### Curing Characteristics

The curing characteristics where determined by the Moving Die Rheometer (MDR) method. The results are presented on Table 7.

The use of Resin C (rosin acid) had a strong influence on the curing behavior of the compound, strongly reducing the t₉₀ and lead to a much softer final compound, as can be derived from the maximum torque (MH) (Table 7). This indicates interference with the curing package, resulting in an acceleration of the cure rate and a limitation of the degree of curing. The accelerated curing could result in premature curing during processing. The limited degree of curing could have a undesired effect on the mechanical properties of the compound. Further, Resin D (Struktol 40 MS) showed an increase of the MDR t₉₀, that means that the cure rate of the compound is reduced, which is also undesirable. The reduced cure rate could result in undercured products or an extended cure time; reducing rate of production. On the other hand low acid rosin esters (resins A & B) did not significantly affect the MDR t₉₀ and resulted in stiffer compounds compared to compounds containing Resin C.

TABLE 7
Curing characteristics

| | | Maximum | Delta S |
|---|---|---|---|
| Sample | t₉₀ (min) | Torque (Nm) | (Nm) |
| 10 phr paraffin oil* | 9.22 | 0.68 | 0.51 |
| 2.5 phr Resin A | 8.13 | 0.68 | 0.50 |
| 5 phr Resin A | 7.62 | 0.59 | 0.42 |
| 10 phr Resin A | 6.65 | 0.54 | 0.36 |
| 2.5 phr Resin B | 7.90 | 0.63 | 0.45 |
| 5 phr Resin B | 7.53 | 0.56 | 0.39 |
| 10 phr Resin B | 6.48 | 0.47 | 0.30 |
| 2.5 phr Resin C | 4.56 | 0.46 | 0.31 |
| 5 phr Resin C | 3.33 | 0.38 | 0.22 |
| 10 phr Resin C | 2.31 | 0.31 | 0.14 |
| 2.5 phr Resin D | 10.94 | 0.63 | 0.46 |
| 5 phr Resin D | 12.15 | 0.63 | 0.46 |
| 10 phr Resin D | 13.58 | 0.69 | 0.49 |
| 2.5 phr Resin E | 8.77 | 0.65 | 0.48 |
| 5 phr Resin E | 8.73 | 0.65 | 0.48 |
| 10 phr Resin E | 8.76 | 0.66 | 0.48 |

*average of two samples

In view of these results the effect interfering with the cure package has been found to be stronger as the acid number (AN) of the resin increases. The effect follows the order Resin C>Resin B>Resin A as do the AN of these resins 161.4>14.8>4.3. This suggests that the rosin acids in the products interfere with the curing process, leading to a lower crosslink density and therefore a softer compound.

### Tensile Properties

To maintain an equal thermal history all tensile sheets were cured for 12 min. at 160° C.

As can be seen in Table 8 compounds with Resin C were softer, having a higher maximum elongation.

The softer compounds have a reduced tensile strength as can also be seen in Table 8. Compounds containing 5 & 10 phr of Resin A and 5 phr of Resin B have only a slightly reduced tensile strength.

The increased softness of the compounds also results in a lower modulus at 200%, 300% and 500% elongation (Table 8), the effects are most visible at 300% and 500% elongation.

TABLE 8
Tensile properties

| | | | Modulus (MPa) at a | | | | | |
|---|---|---|---|---|---|---|---|---|
| | Elonga- | Tensile | given elongation | | | | | |
| | tion at | strength | 25 | 50 | 100 | 200 | 300 | 500 |
| Sample | break (%) | (MPa) | % | % | % | % | % | % |
| 10 phr | 605 | 11.4 | 0.6 | 0.8 | 1.3 | 3.1 | 5.5 | 9.9 |
| paraffin | | | | | | | | |
| oil* | | | | | | | | |
| 2.5 phr | 667 | 11.9 | 0.6 | 0.8 | 1.3 | 3.0 | 5.3 | 9.7 |
| Resin A | | | | | | | | |
| 5 phr | 694 | 11.3 | 0.6 | 0.8 | 1.2 | 2.6 | 4.6 | 8.6 |
| Resin A | | | | | | | | |
| 10 phr | 690 | 11.2 | 0.6 | 0.8 | 1.2 | 2.6 | 4.5 | 8.7 |
| Resin A | | | | | | | | |
| 2.5 phr | 660 | 11.6 | 0.6 | 0.9 | 1.3 | 3.0 | 5.2 | 9.5 |
| Resin B | | | | | | | | |
| 5 phr | 720 | 11.3 | 0.6 | 0.8 | 1.2 | 2.8 | 4.9 | 8.7 |
| Resin B | | | | | | | | |
| 10 phr | 833 | 10.7 | 0.7 | 0.8 | 1.1 | 2.1 | 3.6 | 6.9 |
| Resin B | | | | | | | | |
| 2.5 phr | 823 | 10.5 | 0.7 | 0.9 | 1.3 | 2.5 | 4.0 | 6.8 |
| Resin C | | | | | | | | |
| 5 phr | 822 | 10.1 | 0.7 | 0.9 | 1.4 | 2.6 | 4.2 | 7.0 |
| Resin C | | | | | | | | |
| 10 phr | 857 | 10.6 | 0.8 | 1.1 | 1.5 | 2.9 | 4.7 | 7.7 |
| Resin C | | | | | | | | |
| 2.5 phr | 685 | 11.6 | 0.6 | 0.8 | 1.3 | 3.1 | 5.5 | 9.6 |
| Resin D | | | | | | | | |
| 5 phr | 749 | 11.4 | 0.6 | 0.8 | 1.3 | 2.9 | 4.9 | 8.3 |
| Resin D | | | | | | | | |
| 10 phr | 831 | 11.1 | 0.6 | 0.9 | 1.4 | 2.8 | 4.5 | 7.4 |
| Resin D | | | | | | | | |
| 2.5 phr | 621 | 12.2 | 0.6 | 0.8 | 1.4 | 3.5 | 6.1 | 10.6 |
| Resin E | | | | | | | | |
| 5 phr | 622 | 12.1 | 0.6 | 0.8 | 1.4 | 3.6 | 6.3 | 10.7 |
| Resin E | | | | | | | | |
| 10 phr | 667 | 12.6 | 0.6 | 0.9 | 1.4 | 3.3 | 5.9 | 10.5 |
| Resin E | | | | | | | | |

*average of two samples

1. An inner liner formulation comprising a rosin ester and a butyl rubber, wherein the rosin ester has an acid number of at most 15 mgKOH/g.

2. The formulation of claim 1 wherein the rosin ester has an acid number of at most 10 mgKOH/g, in particular of at most 7.5 mgKOH/g, more in particular of at most 5 mgKOH/g, and even more in particular at most 4.5 mgKOH/g.

3. The formulation of claim 1 wherein the rosin ester has a softening point from 70 to 150° C., in particular from 75 to 125° C. and more in particular from 80 to 105° C.

4. The formulation of any one of claim 1 comprising 1 to 20 phr of rosin ester, in particular 2 to 15 phr of rosin ester, more in particular 2.5 to 10 phr of rosin ester, and even more in particular from 5 to 7.5 phr.

5. The formulation of any one of claim 1 wherein the rosin ester is an ester of a polyhydric alcohol and rosin.

6. The formulation of claim 5 wherein the polyhydric alcohol is selected from glycerol and pentaerithrytol.

7. The formulation of claim 5 wherein the rosin is selected from wood rosin, gum rosin and tall oil rosin.

8. The formulation of any one of claim 1 wherein the butyl rubber is halobutyl rubber, and in particular is bromobutyl rubber.

9. The formulation of any one of claim 1 that does not comprise styreneisobutylene-styrene rubber, styrene-isoprene-styrene rubber, and/or polypropylene rubber.

10. The formulation of any one of claim 1 further comprising carbon black.

11. The formulation of any one of claim 1 having a total De Mattia crack growth cycles (L to L+10) of at least 1500 kcyles, in particular at least 2000 kcycles.

12. The formulation of any one of claim 1 having a green tack adhesion of at least 15 ounces, in particular at least 20 ounces.

13. The formulation of any one of claim 1 having a t90 from 5 to 10 min, in particular from 6 to 9 min as determined by (MDR).

14. A tire inner liner comprising the formulation of any one of claim 1.

15. A method for providing an inner liner formulation of any one of claim 1 comprising mixing a rosin ester with a butyl rubber, wherein the rosin ester has an acid number of at most 15 mgKOH/g.
